(19) United States
(12) Patent Application Publication
(10) Pub. No.: US 2015/0208465 A1
(43) Pub. Date: Jul. 23, 2015

(54) Electric Heating Control System for Controlling Electric Heating of a Load, and Electronic Temperature Sensing Device Including the Same

(71) Applicant: Tsann Kuen (Zhangzhou) Enterprise Co., Ltd., Zhangzhou (CN)

(72) Inventors: Hei-Wang Lee, Zhangzhou (CN); Xiao-Sen Sun, Zhangzhou (CN); Shu Wang, Zhangzhou (CN)

(21) Appl. No.: 14/598,831

(22) Filed: Jan. 16, 2015

(30) Foreign Application Priority Data
Jan. 22, 2014 (CN) 201410029313.X

(51) Int. Cl. H05B 1/02; G05D 23/19

(52) U.S. Cl. CPC H05B 1/02; G05D 23/1917; G05D 23/1919; G05D 23/1927

(57) ABSTRACT

An electric heating control system for controlling electric heating of a load includes a temperature sensing unit to sense a current temperature of the load, a first processing module outputting an intermediate voltage signal according to a predetermined output setting when the current temperature is lower than a target temperature, and a second processing module detecting whether or not continuous output of the intermediate voltage signal by the first processing module conforms to a setting of a predetermined duration, to thereby determine whether or not to output a driving voltage signal to the load.

### CROSS-REFERENCE TO RELATED APPLICATION

This application claims priority to Chinese Application No. 201410029313.X, filed on Jan. 22, 2014.

### FIELD OF THE INVENTION

The invention relates to a control system and a temperature sensing device, and more particularly to an electric heating control system and an electronic temperature sensing device.

### BACKGROUND OF THE INVENTION

Traditional electric heating systems highly depend on manual operation to enable/disable heating of a load (e.g., an electric heater), resulting in safety concerns. Recent electric heating systems employ digital control to control heating of the load, and may include a temperature sensor and a controller. Via comparison between a target temperature and a current temperature sensed by the temperature sensor, the controller may determine whether to continue or disable heating of the load, thereby reducing dependency on manual operation and enhancing safety. However, when the controller malfunctions and fails to disable heating of the load, safety concerns arise.

### SUMMARY OF THE INVENTION

Therefore, an object of the present invention is to provide an electric heating control system that may prevent overheating of a load via a double confirming mechanism.

According to one aspect of the present invention, an electric heating control system for controlling electric heating of a load includes:

a temperature sensing unit configured to sense a current temperature of the load, and to generate a temperature signal that indicates the current temperature;

a first processing module electrically coupled to the temperature sensing unit to receive the temperature signal therefrom, and configured to output an intermediate voltage signal according to a predetermined output setting when the current temperature is lower than a target temperature; and

a second processing module disposed to be electrically coupled to the load, electrically coupled to the first processing module to receive the intermediate voltage signal therefrom, and configured to detect whether or not continuous output of the intermediate voltage signal by the first processing module conforms to a setting of a predetermined duration, to thereby determine whether or not to output a driving voltage signal to the load for electric heating of the load.

Another object of the present invention is to provide an electronic temperature sensing device that may prevent overheating of a load via a double confirming mechanism.

According to another aspect of the present invention, an electronic temperature sensing device adapted for controlling electric heating of a load includes:

a heat conducting component for conducting thermal energy from the load; and

an electric heating control system including:
a temperature sensing unit connected to the heat conducting component to sense the current temperature of the load, and to generate a temperature signal that indicates the current temperature;
a first processing module electrically coupled to the temperature sensing unit to receive the temperature signal therefrom, and configured to output an intermediate voltage signal according to a predetermined output setting when the current temperature is lower than a target temperature; and
a second processing module disposed to be electrically coupled to the load, electrically coupled to the first processing module to receive the intermediate voltage signal therefrom, and configured to detect whether or not continuous output of the intermediate voltage signal by the first processing module conforms to a setting of a predetermined duration, to thereby determine whether or not to output a driving voltage signal to the load.

### BRIEF DESCRIPTION OF THE DRAWINGS

Other features and advantages of the present invention will become apparent in the following detailed description of embodiment with reference to the accompanying drawings, of which:

FIG. 1 is an exploded fragmentary perspective view illustrating an embodiment of an electronic temperature sensing device according to the present disclosure;

FIG. 2 is a fragmentary perspective view illustrating the embodiment;

FIG. 3 is a block diagram of the embodiment; and

FIGS. 4A and 4B cooperatively illustrate a schematic circuit diagram of an electric heating control system of the embodiment.

### DETAILED DESCRIPTION OF THE EMBODIMENT

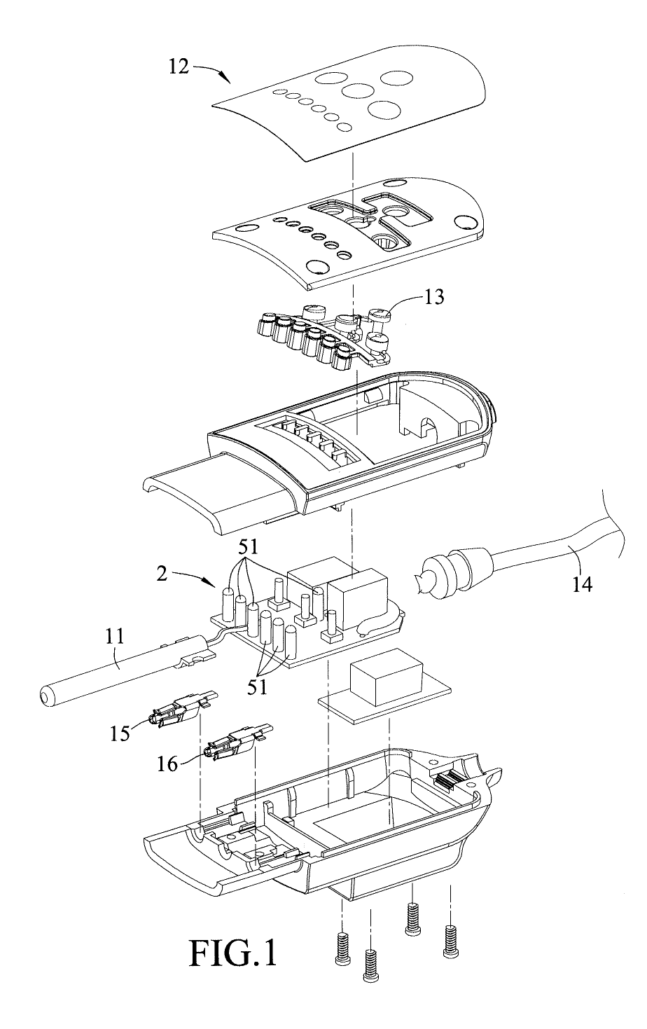

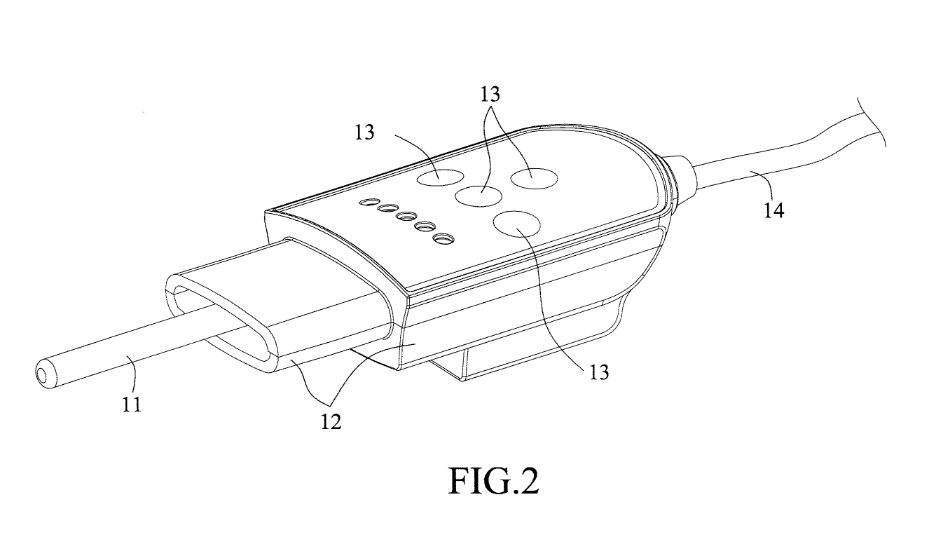

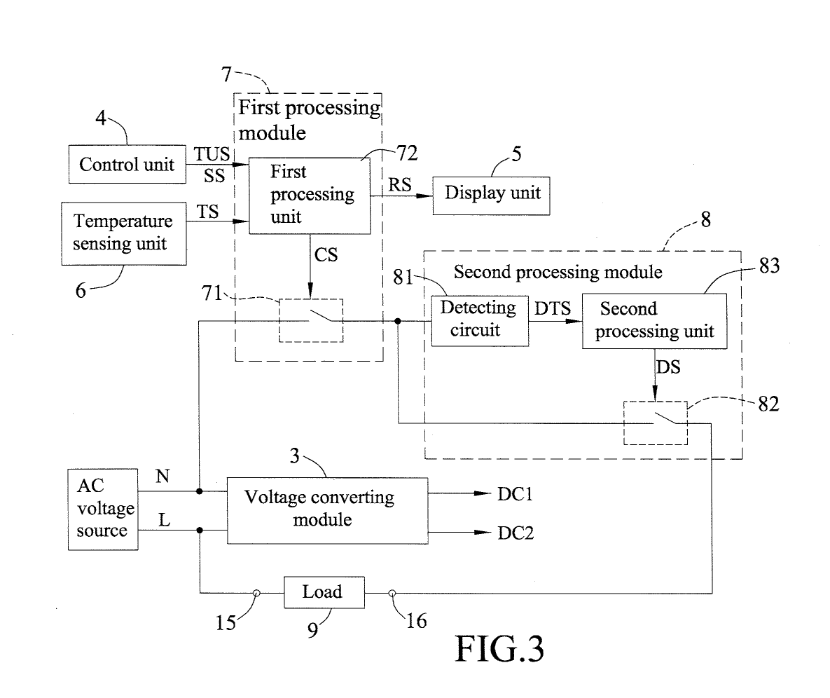

Referring to FIGS. 1 to 3, 4A and 4B, the embodiment of the electronic temperature sensing device according to this invention is adapted to receive a source voltage signal from an alternating current (AC) voltage source and to output a driving voltage signal to a load 9, thereby controlling heating of the load 9, which may be an electric heating element, such as an electric tube heater, etc. In this embodiment, the electronic temperature sensing device includes a heat conducting component 11, a housing 12, an input module 13, a power cord 14 and an electric heating control system 2. The electronic temperature sensing device may provide an AC voltage signal to the load 9 via terminals 15, 16 for the load 9 to convert the AC voltage signal into heat. In this embodiment, the terminal 15 is electrically coupled to a line terminal (L) of the AC voltage source.

The heat conducting component 11 is formed as a bar, and conducts thermal energy from the load 9. The heat conducting component 11 has a first end part to sense the thermal energy from the load 9, and a second end part connected to the electric heating control system 2, thereby conducting the sensed thermal energy to the electric heating control system 2.

The housing 12 is configured for accommodating the electric heating control system 2, and for insertion of the second end part of the heat conducting component 11. The first end part of the heat conducting component 11 extends outwardly of the housing 12.

The input module 13 is disposed on and partly exposed from the housing 12, and is connected to the electric heating control system 2 for facilitating user control of the electric heating control system 2. In this embodiment, the input module 13 includes a plurality of buttons, so that users may use the same to actuate the electric heating control system 2 and to set a target temperature to which the load 9 is to be heated.

In this embodiment, the power cord 14 is disposed to electrically couple the electric heating control system 2 to a neutral terminal (N) and the line terminal (L) of the AC voltage source, and to provide to the electric heating control system 2 the source voltage signal provided by the neutral terminal (N) of the AC voltage source.

The electric heating control system 2 includes a voltage converting module 3, a control unit 4, a display unit 5, a temperature sensing unit 6, a first processing module 7 and a second processing module 8.

The voltage converting module 3 receives an AC voltage input from the line and neutral terminals N) of the AC voltage source, and performs rectification and voltage dropping operation on the AC voltage input, thereby obtaining a first direct current (DC) voltage (DC1) and a second DC voltage (DC2) that are provided to corresponding one(s) of the control unit 4, the temperature sensing unit 6, the first processing module 7 and the second processing module 8. In this embodiment, the first DC voltage (DC1) is 24V and the second DC voltage (DC2) is 5V. However, the present invention should not be limited in this respect.

The control unit 4 receives the second DC voltage (DC2), is electrically coupled to the first processing module 7, and outputs to the first processing module 7, according to user operations on the input module 13, an operation signal (TUS) to switch the first processing module 7 between an activation state and a deactivation state, and a temperature setting signal (SS) that indicates the target temperature. In this embodiment, the control unit 4 includes first to fourth button switches (S2) to (S5) each coupled to the input module 13, so that users may control each of the button switches (S2-S5) to conduct or not conduct via the input module 13. In this embodiment, when the third button switch (S4) conducts, an operation signal (TUS) to cause the first processing module 7 to be in the activation state is provided to the first processing module 7. When the third button switch (S4) does not conduct, an operation signal (TUS) to cause the first processing module 7 to be in the deactivation state is provided to the first processing module 7. In this embodiment, the first, second and third button switches (S2), (S3), (S4) are configured for setting the target temperature. When the first button switch (S2) conducts, a temperature setting signal (SS) to lower the target temperature is provided to the first processing module 7. When the second button switch (S3) conducts, a temperature setting signal (SS) to raise the target temperature is provided to the first processing module 7. When the third button switch (S4) conducts, a temperature setting signal (SS) to set the target temperature to a maximum target temperature is provided to the first processing module 7.

The display unit 5 is electrically coupled to the first processing module 7, and includes a plurality of light emitting diodes 51. Each of the light emitting diodes 51 emits light upon receiving a light emitting signal (RS) from the first processing module 7, thereby allowing users to observe the current target temperature via the display unit 5.

The temperature sensing unit 6 is electrically coupled to the second end part of the heat conducting component 11 to sense a current temperature of the load 9 associated with the thermal energy conducted by the heat conducting component 11, thereby generating a temperature signal (TS) that indicates the current temperature and that is provided to the first processing module 7.

In this embodiment, the first processing module 7 includes a first switch 71 and a first processing unit 72. The first switch 71 is electrically coupled between the second processing module 8 and the neutral terminal (N) of the AC voltage source, which provides the source voltage signal, and receives a control signal (CS) to thereby conduct or not conduct. However, the present invention should not be limited in this respect.

In this embodiment, the first processing unit 72 stores a predetermined output setting therein, receives the first and second DC voltages (DC1), (DC2) from the voltage converting module 3, receives the operation signal (TUS) and the temperature setting signal (SS) from the control unit 4, provides the light emitting signal (RS) to at least one of the light emitting diodes 51 according to the target temperature set by the temperature setting signal (SS), and receives the temperature signal (TS) from the temperature sensing unit 6. The first processing unit 72 compares the current temperature indicated by the temperature signal (TS) with the target temperature, and generates the control signal (CS) according to a comparison result, thereby controlling passage of the source voltage signal through the first switch 71 to serve as an intermediate voltage signal. When the current temperature is lower than the target temperature, the first processing unit 72 generates the control signal (CS) that causes the first switch 71 to conduct or not conduct in a manner that conforms to the predetermined output setting. When the current temperature is higher than the target temperature, the first processing unit 72 generates the control signal (CS) that causes the first switch 71 to not conduct.

The predetermined output setting is associated with a duration of continuous output (i.e., a predetermined output duration) of the intermediate voltage signal by the first processing module 7, and a time interval between two successive continuous outputs (i.e., a predetermined no-output duration) of the intermediate voltage signal. The first processing unit 72 controls the first switch 71 to conduct for the predetermined output duration, and controls the first switch 71 to not conduct for the predetermined no-output duration when the current temperature is lower than the target temperature. In one example, the predetermined output duration is 30 seconds and the predetermined no-output duration is 2 seconds. The first processing unit 72 may be configured to repeat a cycle of causing the first switch 71 to conduct for 30 seconds, to not conduct for 2 seconds, to conduct for 30 second . . . , according to the predetermined output setting when the current temperature is lower than the target temperature.

In this embodiment, the second processing module 8 includes a detecting circuit 81, a second switch 82 and a second processing unit 83. The detecting circuit 81 receives the second DC voltage (DC2) from the voltage converting module 3, is electrically coupled to the first switch 71 for detecting output of the intermediate voltage signal by the first processing module 7, and generates a detected signal (DTS) based upon a detection result. In this embodiment, when output of the intermediate voltage signal is detected by the detecting circuit 81, the detected signal (DTS) thus outputted is a pulsating signal having a frequency equal to that of the AC voltage input. When output of the intermediate voltage signal is not detected by the detecting circuit 81, the detected signal may be a DC voltage signal with 0 volts.

The second switch 82 is electrically coupled between the first switch 71 and the terminal 16 for providing the driving voltage signal to the load 9, and receives a driving signal (DS) to thereby conduct or not conduct.

In this embodiment, the second processing unit 83 stores a setting of a predetermined duration (i.e., a maximum output duration) therein, receives the first and second DC voltages (DC1, DC2) from the voltage converting module 3, and receives the detected signal (DTS) from the detecting circuit 81. The second processing unit 83 generates the driving signal (DS) according to the maximum output duration and the detected signal (DTS). When the second processing unit 83 receives the pulsating detected signal (DTS), which indicates that the first processing module 7 outputs the intermediate voltage signal, the second processing unit 83 determines whether or not continuous output of the intermediate voltage signal is shorter than the maximum output duration (e.g., 60 seconds) according to the detected signal (DTS). When the determination is affirmative, the second processing unit 83 generates the driving signal (DS) to cause the second switch 82 to conduct, thereby allowing passage of the intermediate voltage signal that serves as the driving voltage signal to the load 9. Otherwise, the second processing unit 83 generates the driving signal (DS) to cause the second switch 82 to not conduct, thereby disabling provision of the driving voltage signal to the load 9. In one embodiment, the second processing unit 83 may store the predetermined output setting therein, and the maximum output duration may be equal to the predetermined output duration. In one embodiment, the second processing unit 83 may determine whether or not the output of the intermediate voltage signal conforms to both of the predetermined output duration and the predetermined no-output duration, thereby causing the second switch 82 to conduct or to not conduct. In this embodiment, the second processing unit 83 is further configured to control the second switch 82 to not conduct upon determining, according to the detected signal (DTS), that the intermediate voltage signal is not outputted by the first processing module 7.

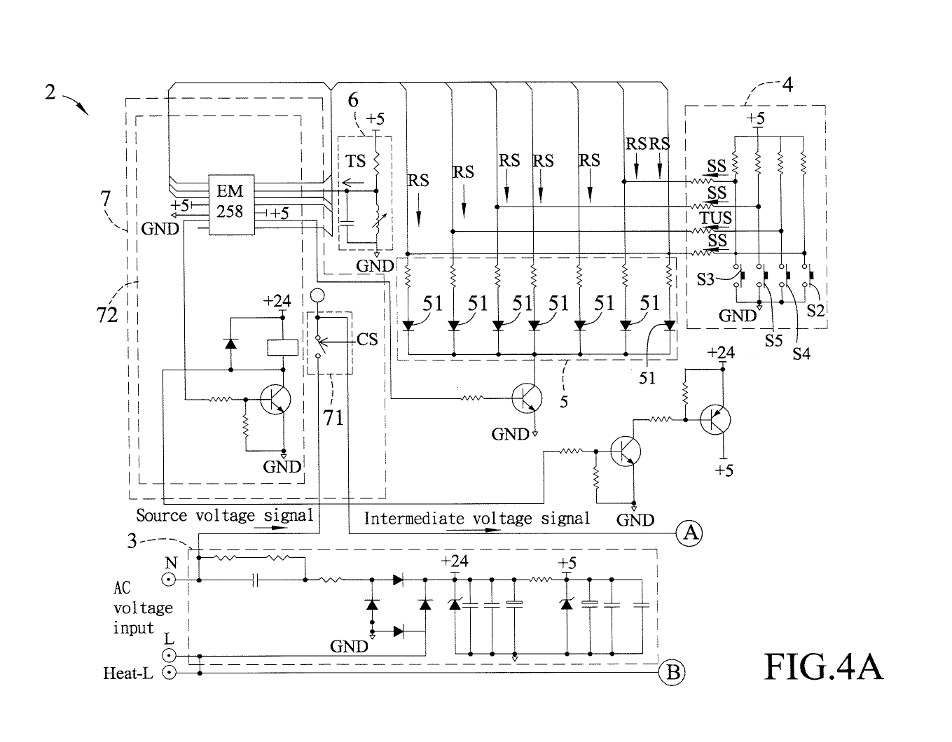

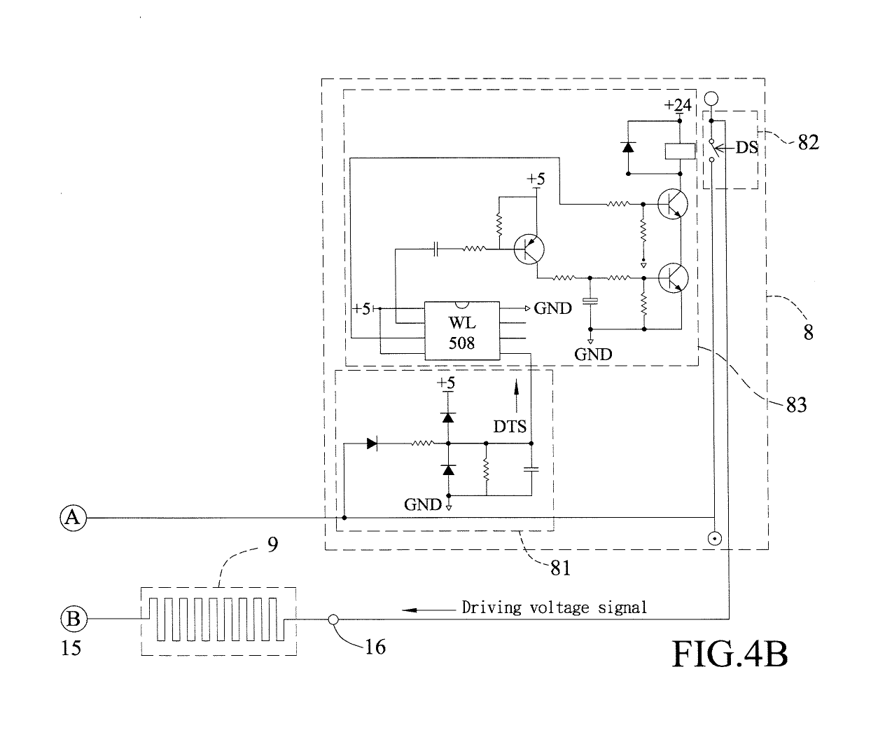

FIGS. 4A and 4B show detailed circuit design of the electric heating control system 2 according to the embodiment of the present disclosure.

In use, a user may press one of the buttons of the input module 13 that corresponds to the button switch (S4) of the control unit 4 to start heating the load 9. At this time, the control unit 4 provides the operation signal (TUS) to the first processing unit 72 to switch the first processing unit 72 to the activation state. Then, the user may press the buttons of the input module 13 that correspond to the button switches (S2), (S3), (S5) to cause the control unit 4 to provide the temperature setting signal (SS) to the first processing unit 72 for setting the target temperature. At this time, the first processing unit 72 provides the light emitting signal (RS) to one of the light emitting diodes 51 of the display unit 5 that corresponds to the target temperature, resulting in light emission of that particular light emitting diode 51 for the user to confirm the currently set target temperature. Simultaneously, the heat conducting component 11 conducts the thermal energy from the load 9 sensed thereby to the temperature sensing unit 6, and the temperature sensing unit 6 thus provides the temperature signal (TS) to the first processing unit 72.

The first processing unit 72 compares the current temperature indicated by the temperature signal (TS) with the target temperature, and controls, using the control signal (CS), the first switch 71 to conduct or not conduct with a regularity that conforms to the predetermined output setting (i.e., to conduct for the predetermined output duration and to not conduct for the predetermined no-output duration) when the current temperature is lower than the target temperature. The detecting circuit 81 detects the intermediate voltage signal provided from the first switch 71, and generates the detected signal (DTS) in accordance with the detection result. The second processing unit 83 determines, according to the detected signal (DTS), whether or not continuous output of the intermediate voltage signal from the first switch 71 conforms to the setting of the predetermined duration, and controls the second switch 82 to conduct when the determination is affirmative, to thereby heat the load 9. When the second processing unit 83 determines that continuous output of the intermediate voltage signal from the first switch 71 does not conform to the setting of the predetermined duration, the second processing unit 83 controls the second switch 82 to not conduct, to thereby disable heating of the load 9 and prevent overheating of the load 9 due to malfunction of the first processing module 7.

The first processing unit 72 controls the first switch 71 to not conduct when the current temperature indicated by the temperature signal (TS) is higher than the target temperature. At this time, the detecting circuit 81 does not detect output of the intermediate voltage signal from the first processing module 7, and generates the appropriate detected signal (DTS) to indicate this condition. The second processing unit 83 accordingly controls the second switch 82 to not conduct, and thus no driving voltage signal is provided to the load 9.

In summary, by virtue of the double confirming mechanism, that is, with the first processing module 7 determining whether to heat the load 9, and the second processing module 8 determining whether the first processing module 7 operates normally, the electronic temperature sensing device of this invention may prevent danger resulting from malfunction of the first processing module 7, which may otherwise lead to overheating of the load 9, to thereby enhance safety.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric heating control system for controlling electric heating of a load, said electric heating control system comprising:
a temperature sensing unit configured to sense a current temperature of the load, and to generate a temperature signal that indicates the current temperature;
a first processing module electrically coupled to said temperature sensing unit to receive the temperature signal therefrom, and configured to output an intermediate voltage signal according to a predetermined output setting when the current temperature is lower than a target temperature; and
a second processing module disposed to be electrically coupled to the load, electrically coupled to said first processing module to receive the intermediate voltage signal therefrom, and configured to detect whether or not continuous output of the intermediate voltage signal by said first processing module conforms to a setting of a predetermined duration, to thereby determine whether or not to output a driving voltage signal to the load for electric heating of the load.

2. The electric heating control system according to claim 1, wherein said second processing module does not output the driving voltage signal upon detecting that continuous output of the intermediate voltage signal by said first processing module lasts for longer than the predetermined duration.

3. The electric heating control system according to claim 1, wherein, the predetermined output setting is associated with a duration of continuous output of the intermediate voltage signal by said first processing module, and a time interval between two successive continuous outputs of the intermediate voltage signal.

4. The electric heating control system according to claim 3, wherein the predetermined duration is equal to the duration of continuous output of the intermediate voltage signal that is associated with the predetermined output setting, and said second processing module does not output the driving voltage signal upon detecting that continuous output of the intermediate voltage signal from said first processing module lasts for longer than the predetermined duration.

5. The electric heating control system according to claim 1, wherein said first processing module does not output the intermediate voltage signal when the current temperature is higher than the target temperature.

6. The electric heating control system according to claim 1, wherein said first processing module includes:
a first switch disposed to receive a source voltage signal from an alternating current (AC) voltage source, and configured to allow passage of the source voltage signal to serve as the intermediate voltage signal when conducting; and
a first processing unit electrically coupled to said temperature sensing unit and said first switch, and configured to control said first switch to conduct or not conduct in a manner that conforms to the predetermined output setting when the current temperature is lower than the target temperature, and to control said first switch to not conduct when the current temperature is higher than the target temperature.

7. The electric heating control system according to claim 1, wherein said second processing module includes:
a detecting circuit electrically coupled to said first processing module for detecting output of the intermediate voltage signal by said first processing module, so as to generate a detected signal;
a second switch electrically coupled to said first processing module to receive the intermediate voltage signal therefrom, and configured to allow output of the intermediate voltage signal to serve as the driving voltage signal when conducting; and
a second processing unit electrically coupled to said detecting circuit to receive the detected signal therefrom, and to said second switch, and configured to control said second switch to conduct upon determining, according to the detected signal, that continuous output of the intermediate voltage signal by said first processing module conforms to the setting of the predetermined duration, and to control said second switch to not conduct upon determining, according to the detected signal, that continuous output of the intermediate voltage signal does not conform to the setting of the predetermined duration.

8. The electric heating control system according to claim 7, wherein said second processing unit is further configured to control said second switch to not conduct upon determining, according to the detected signal, that no intermediate voltage signal is outputted by said first processing module.

9. An electronic temperature sensing device adapted for controlling electric heating of a load, said electronic temperature sensing device comprising:
a heat conducting component for conducting thermal energy from the load; and
an electric heating control system including:
a temperature sensing unit connected to said heat conducting component to sense a current temperature associated with the thermal energy, thereby to generating a temperature signal that indicates the current temperature;
a first processing module electrically coupled to said temperature sensing unit to receive the temperature signal therefrom, and configured to output an intermediate voltage signal according to a predetermined output setting when the current temperature is lower than a target temperature; and
a second processing module disposed to be electrically coupled to the load, electrically coupled to said first processing module to receive the intermediate voltage signal therefrom, and configured to detect whether or not continuous output of the intermediate voltage signal by said first processing module conforms to a setting of a predetermined duration, to thereby determine whether or not to output a driving voltage signal to the load.

10. The electronic temperature sensing device according to claim 9, wherein said second processing module does not output the driving voltage signal upon detecting that continuous output of the intermediate voltage signal by said first processing module lasts for longer than the predetermined duration.

11. The electronic temperature sensing device according to claim 9, wherein the predetermined output setting is associated with a duration of continuous output of the intermediate voltage signal by said first processing module, and a time interval between two successive continuous outputs of the intermediate voltage signal.

12. The electronic temperature sensing device according to claim 11, wherein the predetermined duration is equal to the duration of continuous output of the intermediate voltage signal that is associated with the predetermined output setting, and said second processing module does not output the driving voltage signal upon detecting that continuous output of the intermediate voltage signal received from said first processing module lasts for longer than the predetermined duration.

13. The electronic temperature sensing device according to claim 9, wherein said first processing module does not output the intermediate voltage signal when the current temperature is higher than the target temperature.

14. The electronic temperature sensing device according to claim 9, wherein said first processing module includes:
a first switch disposed to receive a source voltage signal from an alternating current (AC) voltage source, and configured to allow passage of the source voltage signal to serve as the intermediate voltage signal when conducting; and
a first processing unit electrically coupled to said temperature sensing unit and said first switch, and configured to control said first switch to conduct or not conduct in a manner that conforms to the predetermined output setting when the current temperature is lower than the target temperature, and to control said first switch to not conduct when the current temperature is higher than the target temperature.

15. The electronic temperature sensing device according to claim 9, wherein said second processing module includes:
a detecting circuit electrically coupled to said first processing module for detecting output of the intermediate voltage signal from said first processing module, so as to generate a detected signal;
a second switch electrically coupled to said first processing module to receive the intermediate voltage signal therefrom, and configured to allow passage of the intermediate voltage signal to serve as the driving voltage signal when conducting; and
a second processing unit electrically coupled to said detecting circuit to receive the detected signal therefrom, and to said second switch, and configured to control said second switch to conduct upon determining, according to the detected signal, that continuous output of the intermediate voltage signal conforms to the setting of the predetermined duration, and to control said second switch to not conduct upon determining, according to the detected signal, that continuous output of the intermediate voltage signal does not conform to the setting of the predetermined duration.

16. The electronic temperature sensing device according to claim 15, wherein said second processing unit is further configured to control said second switch to not conduct upon determining, according to the detected signal, that no intermediate voltage signal is outputted by said first processing module.

17. The electronic temperature sensing device according to claim 9, wherein said electric heating control system further includes:
a control unit electrically coupled to said first processing module, and configured to output to said first processing module an operation signal to switch said first processing module between an activation state and a deactivation state, and a temperature setting signal that indicates the target temperature.

18. The electronic temperature sensing device according to claim 17, further comprising:
a housing accommodating therein said electric heating control system,
wherein said heat conducting component has a first end part that extends outwardly of said housing and that is adapted for sensing the thermal energy from the load, and a second end part that is accommodated in said housing and that is connected to said temperature sensing unit.

19. The electronic temperature sensing device according to claim 18, further comprising:
an input module disposed on said housing and connected to said control unit, and configured to cause said control unit to generate the operation signal and the temperature setting signal in response to a user operation thereon.
